(19) United States
(12) Patent Application Publication
(10) Pub. No.: US 2002/0174025 A1
(43) Pub. Date: Nov. 21, 2002

(54) Method and system for providing targeted advertising and personalized customer services

(76) Inventors: John R. Hind, Raleigh, NC (US); James M. Mathewson II, Chapel Hill, NC (US); Marcia L. Peters, Durham, NC (US)

Correspondence Address: Esther H. Chong, Esquire, Synnestvedt & Lechner LLP, 2600 Aramark Tower, 1101 Market Street, Philadelphia, PA, 19107-2950, US

(21) Appl. No.: 09/859,359

(22) Filed: May 17, 2001

(51) Int. Cl. G06F 17/60

(52) U.S. Cl. 705/26

(57) ABSTRACT

A method and system for providing targeted advertising and personalized customer services using wireless communication devices. The method includes the steps of initiating wireless communication with the wireless communication device, automatically receiving preference information from the wireless communication device through the initiated communication, and providing, based on the preference information, a personalized customer service in response to a user's request. The wireless communication device can be, e.g., a PDA, a mobile phone, a two-way pager, or a shopping cart attachment device. The shopping cart attachment device is attached to a shopping cart operated by the user and is capable of reading RFID-tagged products placed in the shopping cart or reading a customer card carrying the preference information or a unique customer ID associated with preference information prestored in a central location.

### BACKGROUND OF THE INVENTION

1. Field of the Invention

The present invention relates to customer service providing systems and, more particularly, to a method and system for providing targeted advertising and personalized customer services using wireless communication devices.

2. Discussion of the Related Art

Due to recent developments in wireless technology, product information such as the availability of a product at a particular store, the price of the product at the store, the colors and sizes of the product available at the store, etc., can be displayed directly on a personal digital assistant (PDA) carried by a customer. This allows the customer to be alerted about products without having to visit the store or without having to initiate communication with the store.

GeePS, Inc., a wireless application service provider, offers such services to their customers. According to the GeePS system, a customer who is interested in receiving such services must register with GeePS either online or by phone or mail. At the time of the registration, the customer provides his or her zip code and age. Once the customer is registered, GeePS forwards product information and other promotional information from different retailers to the customer's PDA based on the customer's zip code and age The customer can dictate the amount of messages he wishes to receive, the times at which the messages are to be received, and the categories or stores that are associated with these messages.

If the customer places a special order with a particular merchant, the GeePS service can be used to automatically alert the customer via the customer's PDA when the ordered item is ready for the customer pick-up. The alert message may also indicate the time and location at which the ordered item can be picked up. More information about the customer services offered by GeePS can be found at the website of http://www.geeps.com.

The customer services offered by GeePS and other similar service providers, however, are limited to alerting customers about products. Furthermore, the customer must inform the service provider each time the customer wishes to change the manner in which the customer receives the messages. For example, if the customer wishes to receive product information from a store not previously designated by the customer, the customer must contact the service provider and notify the service provider about the change. This process can be time consuming and tedious for the customer since the customer's product preference can change on a regular basis. As time passes, the customer is less likely to update the customer's message preferences. This results in a transmission of product information to the customer which will be less interesting to the customer, thereby diminishing the effectiveness of the messages.

Accordingly, there is a need for a method and system for providing targeted advertising and customer services directly to the customer which overcomes the problems encountered in conventional service providing systems.

### SUMMARY OF THE INVENTION

The present invention provides a method and system for providing targeted advertising and personalized customer services to customers using wireless communication devices such as PDAs or mobile phones carried by the customers, which overcomes the above-described problems and other problems encountered in conventional advertising and customer-service providing systems and methods.

In accordance with one embodiment, the present invention provides a communication interface for communicating with a wireless communication device such as a PDA carried by a customer. The PDA stores therein preference information of the customer identifying the products, brands, language, stores, etc. preferred by the customer. The communication interface initiates wireless communication with the PDA using known short-range wireless communication techniques such as Bluetooth or infrared techniques, and obtains automatically the preference information from the PDA. Based on the preference information, a data processor coupled to the communication interface selects advertisements that will be likely to interest the customer and displays them on a display device of the customer's PDA.

The PDA is also configured to provide a list of customer services that are offered by the data processor, such as providing a translation of product information in the language preferred by the customer. The customer selects one of the customer services identified on the list and provides additional information if necessary to implement the selected customer service. The data processor receives the customer's selection of the customer service and any additional input from the customer's PDA, and provides the selected customer service to the customer via the PDA. The provided customer service is personalized based on the customer's preference information.

In accordance with another embodiment, the wireless communication device is a shopping cart attachment device attached to a shopping cart operated by the customer. The customer is provided with a customer card such as a RFID (Radio Frequency Identification) tagged card which is prestored with the customer's preference information. The shopping cart attachment device is configured to scan the preference information from the customer card carried by the customer. Then the scanned preference information is communicated to the data processor using short-range wireless communication techniques. Based on this preference information, the data processor provides targeted advertising and/or personalized customer service to the customer using a display device of the shopping cart attachment device.

In accordance with another embodiment, each customer's preferences are prestored in a central location and are associated with a unique customer ID. The customer ID is stored on the customer card carried by the customer. The shopping cart attachment device reads the customer ID from the customer card. Based on this customer ID, the data processor retrieves prestored preference information associated with this customer ID. Based on the retrieved preference information, the data processor provides targeted advertising and/or personalized customer service to the customer on a display device of the shopping cart attachment device.

In accordance with another embodiment, the wireless communication device is a PDA, mobile phone, two-way pager, or other device carried by the customer. The present invention further provides a shopping cart attachment device attached to a shopping cart operated by the customer, and RFID-tagged products. A RFID tag of a product is configured to store therein information about the product, such as the name of the manufacturer, the name and suggested price of the product, etc. The shopping cart attachment device is configured to automatically scan RFID-tagged products that the customer places in the shopping cart as the customer shops, and to communicate the scanned product information to the customer's wireless communication device. The scanned product information functions in this embodiment as the preference information since it identifies products currently preferred by the customer. The wireless communication device then communicates the scanned preference information to the data processor which in turns provides targeted advertisements and/or personalized customer service information on the display device of the wireless communication device.

### BRIEF DESCRIPTION OF THE DRAWINGS

FIG. 1 is a block diagram of a system for providing targeted advertising and personalized customer services using a wireless communication device according to a first embodiment of the present invention.

FIG. 2 is a block diagram of a system for providing targeted advertising and personalized customer services using a wireless communication device in accordance with a second embodiment of the present invention.

FIG. 3 is a diagram of an example of a shopping cart which can be used in the system of FIG. 2 according to the second embodiment of the present invention.

FIG. 4 is a block diagram of a system for providing targeted advertising and personalized customer services using a wireless communication device according to a third embodiment of the present invention.

FIG. 5 is a block diagram of a system for providing targeted advertising and personalized customer services using a wireless communication device according to a fourth embodiment of the present invention.

FIG. 6 is a diagram of an example of a shopping cart which can be used in the system of FIG. 5 according to the fourth embodiment of the present invention.

### DETAILED DESCRIPTION OF THE PREFERRED EMBODIMENTS

In the drawings, the same reference numerals are used to indicate the same elements.

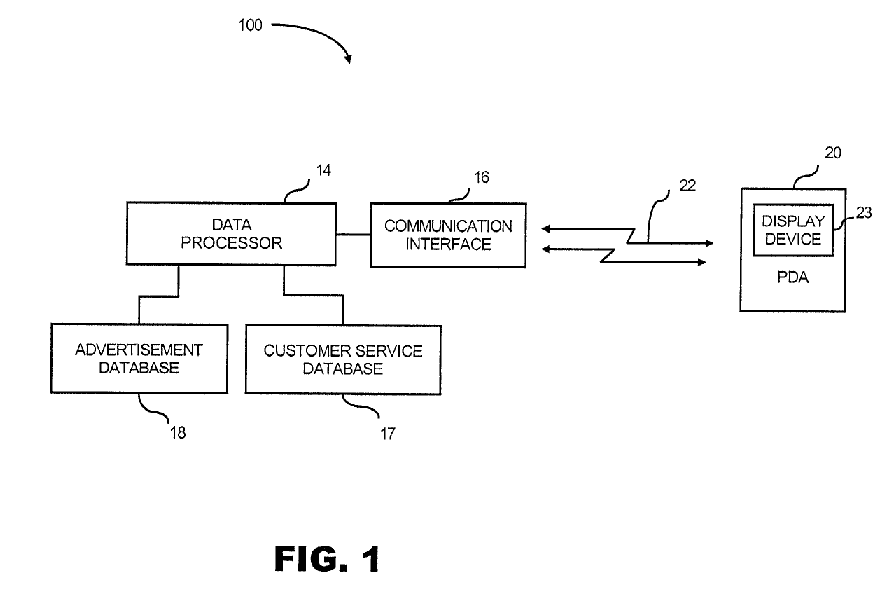

FIG. 1 is a block diagram of a system 100 for providing targeted advertising and personalized customer services using a wireless communication device according to a first embodiment of the present invention. The system 100 can be implemented in or for a store, shopping mall, or other shopping area or environment. As shown in FIG. 1, the system 100 includes a data processor 14, a communication interface 16, a customer service database 17, an advertisement database 18, and at least one PDA 20 carried by a user such as a customer, all operatively coupled.

The PDA 20 is a conventional PDA capable of short-range wireless communication 22 with the communication interface 16 according to known communication techniques such as infrared communication or “Bluetooth” techniques. Bluetooth techniques involve providing a small, inexpensive radio unit into mobile devices such as PDAs, mobile phones, PCs. Since the Bluetooth radio unit is designed according to a predetermined standard, it allows mobile devices having the Bluetooth radio units to communicate directly with each other when they come into range without the use of cables or network infrastructure. The Bluetooth standard defines protocols for establishing communication between two selected devices and/or multiple selected devices. Further information regarding the Bluetooth standard and technology is available at the website of http://www.bluetooth.com. Also, U.S. Pat. No. 5,974,238 to Chase, Jr., issued on Oct. 26, 1999, which is herein fully incorporated by reference, describes in detail the operation and components of a conventional PDA.

To provide short-range wireless communication 22 between the PDA 20 and the communication interface 16, e.g., using Bluetooth techniques, each of the PDA 20 and the communication interface 16 includes therein a Bluetooth radio unit known in the art. A Bluetooth radio unit includes both hardware (e.g., antenna, transmitter, etc.) and software for implementing short-range wireless communication. When the PDA 20 carried by the customer is present within a predetermined communication range of the communication interface 16 and the PDA 20 is in a state where communication is enabled, the communication interface 16 initiates communication with the PDA 20 through the Bluetooth radio units according to Bluetooth techniques, and is able to access automatically certain information or files stored in the PDA 20, such as shopping list files, to-do list information, purchase history, product preferences, etc. One or any combination of this information is referred to herein as “preference information” identifying products, brands, stores, language, color, currency, size, or any other item preferred by the customer.

The communication interface 16 transmits the preference information collected from the customer's PDA 20 to the data processor 14. The data processor 14 then processes the preference information to select appropriate advertisements for the customer. To select appropriate advertisements that would be likely to interest the customer, i.e., to provide targeted advertising to the customer, the data processor 14 correlates the preference information with a list of advertisements that are available in the store and is configured to select appropriate advertisement(s) based on the correlation results according to certain criteria. The advertisements can be stored in the advertisement database 18 or any other location accessible by the data processor 14. The selected advertisements are communicated to the customer's PDA 20 via the short-range wireless communication 22, and displayed on a display device 23 such as a screen on the PDA 20. Different targeted advertisements may be displayed on the display device 23 as the customer roams around the store or appropriate shopping area.

If the customer is in need of a particular customer service, the customer can request it using the PDA 20. The PDA 20 is provided with software which identifies a list of customer services offered by the system 100. Examples of customer services that can be offered by the system 100 include, but are not limited to, providing a particular location or store aisle number at which a particular product can be found, providing directions to a store, providing the location of a store if the system is implemented in a larger context such as a shopping mall, providing an automatic translation of product information or other information according to the customer's preferred language including Braille or audio for a vision-impaired customer, providing an automatic currency conversion of price according to the customer's preferred currency, providing sales and other promotional information for products, and other product information (e.g., availability, price, etc.), providing an estimate of order time for an out-of-stock item, providing a discount on an item to substitute for an out-of stock item, providing extended warranties, extended product specifications, application tips and/or configuration tips, providing a discount or targeted advertising for related or accessory items, etc. All of these customer services are provided based on the customer's preference information such as the customer's preferred products, brands, sizes, price range, color, stores, language, currency, etc., so that most appropriate and personalized customer services can be provided to the customer. Any information necessary to provide such customer services can be stored in the customer service database 17 or other location accessible by the data processor 14.

From the list of customer services offered by the system 100, the customer selects one from the list using an input unit of the PDA 20. Depending on which customer service is selected, the PDA 20 is configured to request additional information from the customer if it is needed to provide the requested customer service. For example, if the customer has selected a currency conversion service (e.g., from Canadian currency to the customer's preferred currency which is provided in the preference information), the PDA 20 may be configured to request from the customer the product information and the price of the product in Canadian currency.

Once the customer selects his or her desired customer service and provides any additional information as needed, the PDA 20 is configured to transmit this 20 information to the communication interface 16 via the wireless communication 22. The communication interface 16 then transmits the same information to the data processor 14 which in turn processes the customer's request for the particular customer service. For example, if the customer has requested a price conversion service, then the data processor 14 may perform the monetary conversion calculations, or the data processor 14 may retrieve precalculated information stored in the customer service database 17. Then the data processor 14 provides the requested customer service by displaying the requested information on the display device 23 of the customer's PDA 20 via the short-range wireless communication 22. For instance, the data processor 14 displays the price of the requested product in US dollars on the display device 23. Since the customer services are provided based on the preference information of the customer, more personalized customer services tailored to accommodate the specific preference and needs of the customer are provided in the present invention than are available using prior art systems.

Accordingly, the present invention advantageously provides targeted advertising and personalized customer services using the PDA or other wireless communication device carried by the customer based on the customer's preference information collectable from the wireless communication device.

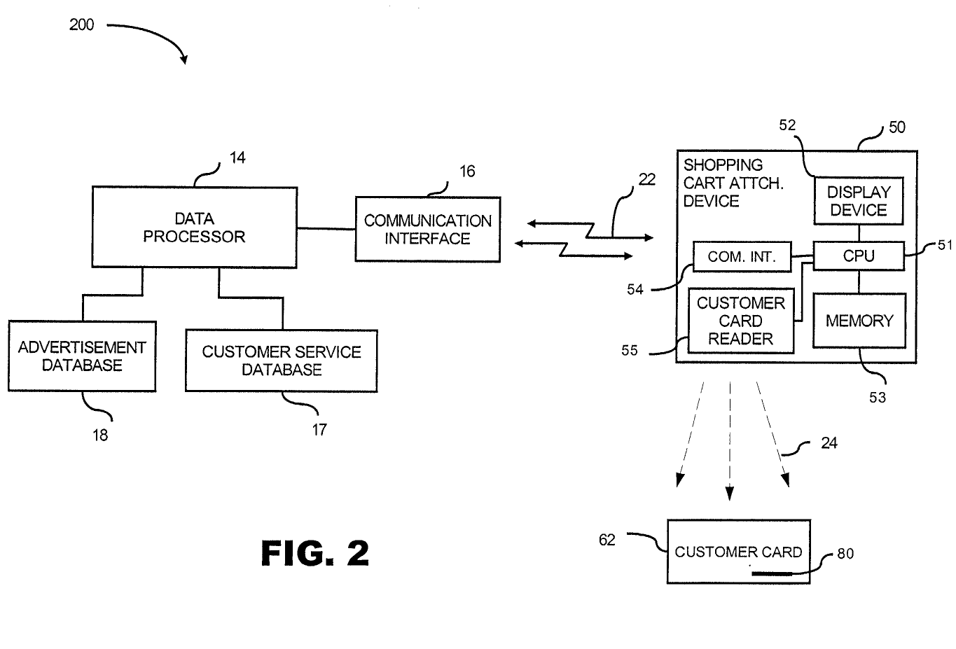

FIG. 2 is a block diagram of a system 200 for providing targeted advertising and personalized customer services using a wireless communication device according to a second embodiment of the present invention. As shown in FIG. 2, the system 200 includes a data processor 14, a communication interface 16, a customer service database 17, an advertisement database 18, and a shopping cart attachment device 50, all operatively coupled. In this embodiment, in lieu of the customer's PDA 20 (FIG. 1), the communication interface 16 communicates with the shopping cart attachment device 50.

The shopping cart attachment device 50 is preferably installed on a conventional shopping cart that customers use during their shopping. The shopping cart attachment device 50 includes a CPU (Central Processing Unit) 51, a display device 52, memory 53, a communication interface 54, and a customer card reader 55, all operatively coupled. The communication interface 54 is configured to perform short-range wireless communication 22 with the communication interface 16 using known communication techniques such as infrared or Bluetooth communication techniques, a combination of Bluetooth and wireless or wired LAN, etc.

The customer card reader 55 is a conventional card reader for reading a customer card 62 such as a membership card, a credit card, a debit card, a customer ID card such as Harris Teeter's VIC, etc. The customer card 62 includes a storage unit 80 for storing the customer's personal information, preference information, etc. The storage unit 80 can be in the form of an optical medium, a magnetic stripe, a chip, a RFID (Radio Frequency Identification) tag, a hologram, etc. Depending on the type of the storage unit 80, the type of the customer card reader 55 will vary. For example, if the storage unit 80 of the customer card 62 is a RFID tag, the customer card reader 55 will be a RFID tag reader for scanning radio signals from the RFID tag wirelessly. If the storage unit 80 of the customer card 62 is a semiconductor chip, then the customer card reader 55 is a smart card reader for reading the chip when the customer card 62 is inserted into the card reader 55. All these storage units and card readers are well known in the art. If the storage unit 80 is a RFID tag, the customer's preference information prestored in the RFID tag of the customer card 62 can be updated on a regular basis by rewriting wirelessly the information stored in the RFID tag according to known RFID tag techniques as the customer's preference changes. In addition, the storage unit 80 can be configured to store therein the demographic information about the owner of the card 62. The demographic information can supplement the preference information to provide more targeted advertising and more personalized customer services.

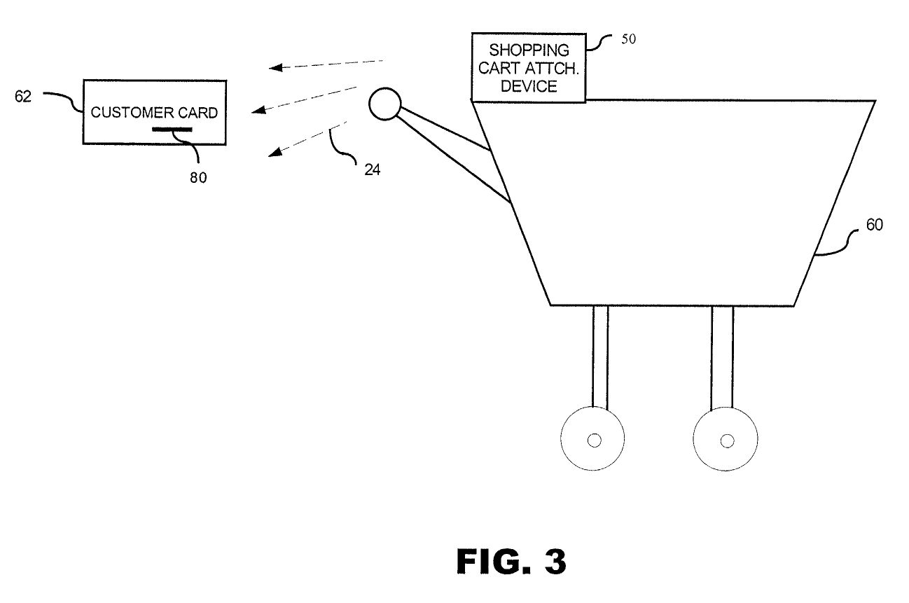

FIG. 3 is a diagram of a shopping cart which can be used in the system 200 according to the second embodiment of the present invention. As shown in FIGS. 2 and 3, the shopping cart attachment device 50 is preferably installed or attached to a shopping cart 60 or any other shopping cart. When a particular customer obtains the shopping cart 60 and carries out shopping activities using the shopping cart 60, the preference information stored in the storage unit 80 of the customer card 62 carried by the customer is read either automatically (e.g., when the storage unit 80 is a RFID tag) or by operating the reader 55 (e.g., by inserting the card 62 into the reader 55). The card reader 55 reads the preference information stored in the storage unit of the customer card 62. The read preference information can be stored temporarily in the memory 53 if needed, and is transmitted to the CPU 51 which in turn transmits it to the data processor 14 through the communication interfaces 54 and 16.

Once the preference information is collected, the data processor 14 can select appropriate advertisements based on the preference information and display them on the display device 52 of the attachment device 50. Also, similarly to the PDA 20 in FIG. 1, the shopping cart attachment device 50 is configured to provide a list of customer services that are offered by the system 200. If the customer requests a particular service by selecting it from the list, the data processor 14 processes this request based on the collected preference information as discussed above in connection with FIG. 1. The targeted advertisements and/or personalized customer service information is then sent to the shopping cart attachment device 50 and displayed on the display device 52 of the attachment device 50 for viewing by the customer.

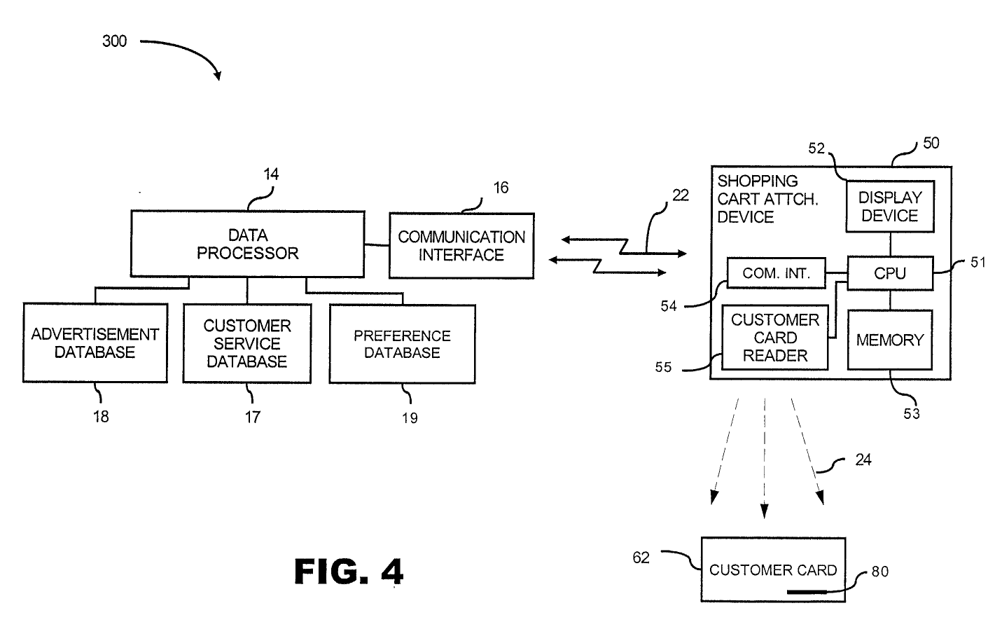

FIG. 4 is a diagram of a system 300 for providing targeted advertising and personalized customer services using a wireless communication device according to a third embodiment of the present invention. In the third embodiment, the customer's preference information is prestored at a central location and is retrieved selectively based on a unique customer ID associated with the stored preference information. The unique customer ID is stored in a customer card 62 at the storage unit 80.

As shown in FIG. 4, the system 300 includes all the components shown in FIG. 2 and further includes a preference database 19 accessible by the data processor 14. The customer card reader 55 reads the customer ID stored in the storage unit 80 of the customer card 62. The obtained customer ID is sent to the CPU 51 which in turn sends it to the data processor 14 via the wireless communication 22. The data processor 14 retrieves from the preference database 19 or the like the preference information associated with this customer ID. Then, the data processor 14 processes the preference information as discussed above in the second embodiment to provide targeted advertisements and/or personalized customer services.

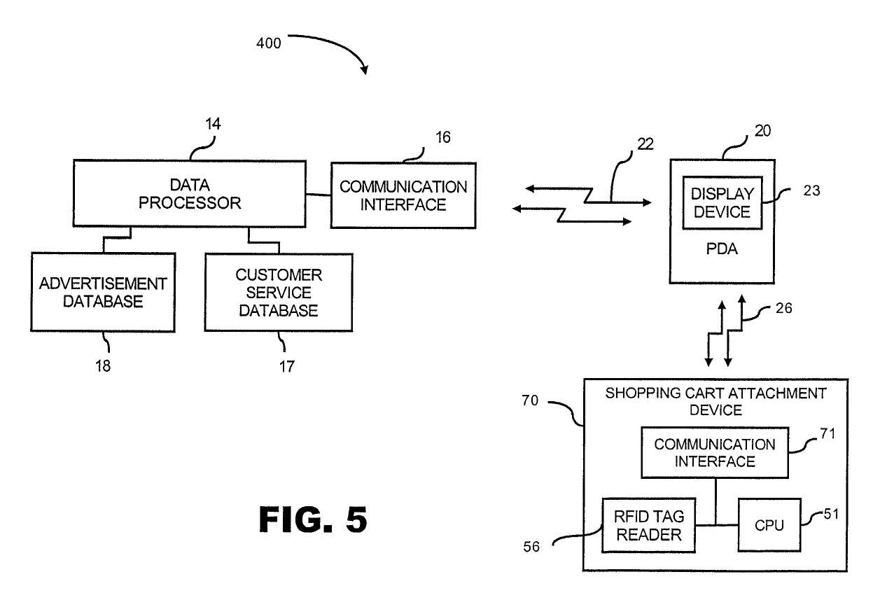

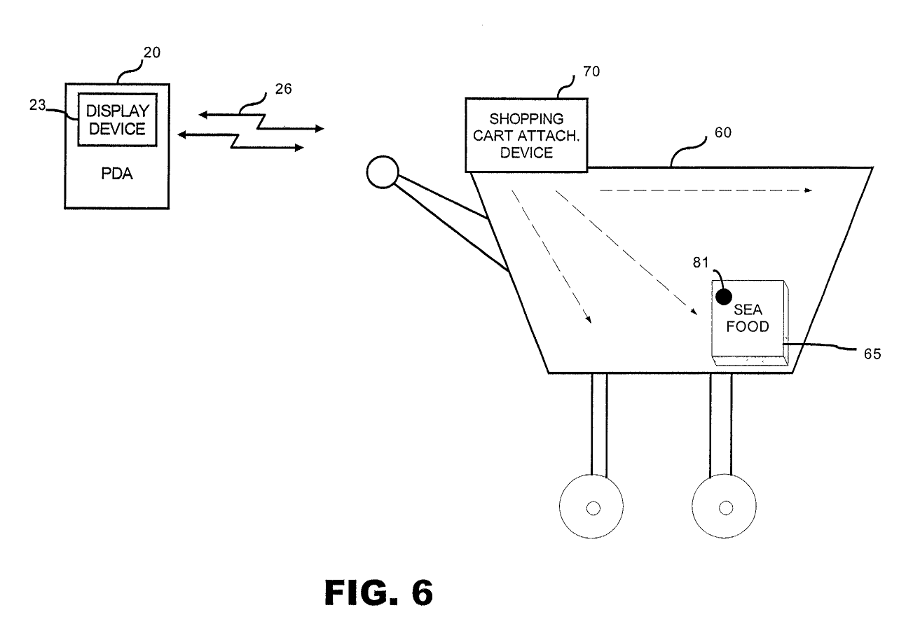

FIG. 5 is a block diagram of a system 400 for providing targeted advertising and personalized customer services using at least one wireless communication device and FIG. 6 is a diagram showing a shopping cart for use in the system 400, all according to a fourth embodiment of the present invention. In this embodiment, each of the items sold at the store or the shopping area includes a conventional RFID tag storing therein product information such as a retail SKU number (e.g., UPC - universal product code) identifying the name, manufacturer and/or suggested price of the product, a unique serial number identifying the product, or both the SKU number and the unique serial number.

As shown in FIGS. 5 and 6, the system 400 includes a data processor 14, a communication interface 16, a customer service database 17, an advertisement database 18, a PDA 20, and a shopping cart attachment device 70, all operatively coupled.

The shopping cart attachment device 70 is attached to a shopping cart 60 or the like and is capable of automatically reading RFID tagged items as they are placed in or removed from the shopping cart 60. The attachment device 70 is described in detail in a copending U.S. Application No.______ (Attorney Docket No. RSW920010093US1), filed on May 17, 2001, and entitled “Method and System for Providing Shopping Assistance Using RFID-tagged Items”, which is herein fully incorporated by reference. Particularly, as described in the above copending U.S. Application No.______ (Attorney Docket No. RSW920010093US1), the attachment device 70 includes a communication interface 71, a RFID tag reader 56 and a CPU51, operatively coupled. The communication interface 71 is configured to perform short-range wireless communication 26 with the customer's PDA 20 using known communication techniques such as Bluetooth or infrared communication techniques. The RFID tag reader 56 is configured to scan automatically any item 65 having a RFID tag 81 placed in the shopping cart 60 to which the shopping cart attachment device 70 is attached.

The PDA 20 is configured to carry out short-range comminations 22 with the communication interface 16 and short-range communications 26 with the shopping cart attachment device 70. One skilled in the art would readily understand that the PDA 20 can be replaced with any other wireless communication device such as a mobile phone, a two-way pager, etc., as long as it is capable of carrying out the short-range wireless communications 22 and 26.

As the customer places RFID-tagged items into the customer's shopping cart 60 during his shopping process, the RFID tag reader 56 reads automatically the product information stored in the RFID tag of the product. The mere act of placing the RFID-tagged product in the shopping cart 60 automatically triggers reading of the RFID tag of the product. The scanned product information functions as the customer's current preference information since it identifies products that are currently preferred by the customer. The RFID tag reader 56 communicates this preference information to the communication interface 71 which in turn communicates it to the customer's PDA 20 through the short range wireless communication 26. The PDA 20 then communicates the same preference information to the data processor 14 via the short-range wireless communications 22.

In some embodiments, in addition to this preference information (product information) obtained by scanning the RFID-tagged items placed in the shopping cart 60, the preference information prestored in the PDA 20 may also be collected by the data processor 14 as discussed above in connection with FIG. 1. The current and prestored preference information can be combined to identify the most updated and accurate list of preferred items for the customer. Based on the preference information collected by the data processor 14, the data processor 14 then provides targeted advertising and personalized customer services as discussed above. The customer can select desired customer services from a list of available customer services using the customer's PDA 20 as discussed above. The data processor 14 sends the targeted advertisements and/or personalized customer service information to the customer's PDA 20 and displays it on the display device 23 for viewing by the customer.

In this embodiment, since the display device 23 of the PDA 20 is used to display information to the customer, the shopping cart attachment device 70 need not be equipped with a display device, and the size and the structure of the shopping cart attachment device 70 can be reduced and simplified.

In another embodiment, instead of communicating the preference information collected from the RFID-tagged items through the PDA 20 from the attachment device 70 to the communication interface 16, the attachment device 70 can be configured to communicate this information directly with the communication interface 16. Any information to be displayed to the customer, however, will still be displayed on the display device 23 of the PDA 20.

In all these embodiments, in addition to the customer services that can be specifically requested by the customer, certain personalized customer services can be provided automatically upon the detection of the customer ID or other information. For example, when the data processor 14 obtains a unique customer ID (e.g., from the customer card 62) or the identity of the products placed in the shopping cart, the data processor 14 searches appropriate databases to determine if any warning messages or product recall messages exist that are associated with the products placed in the shopping cart or with products previously purchased by the customer identifiable by the customer ID. If such messages are found, the data processor 14 displays them to the customer, e.g., on the PDA 20 or the attachment device 50. For instance, if the customer places a replacement belt for a certain model of vacuum cleaner into the shopping cart, the data processor 14 may display a product recall message indicating that the vacuum cleaner needs to be checked out for a potential fire hazard defect.

If the system 100, 200, 300 or 400 is implemented in a large area such as a shopping mall, the wireless communication 22 or 26 can be achieved by using a combination of Bluetooth and wired LAN (Local Access Network), a combination of Bluetooth and wireless LAN, or any other combination network capable of implementing the wireless communication 22 or 26 in large areas. Such networks allow the data processor 14 to communicate with the PDA 20 or the shopping cart attachment device 50 or 70 wirelessly through the communication interface 16 as the customer roams through the shopping malls or other large areas. Hardware and/or software configurations for implementing this kind of combination network are known in the art.

For use with the present invention, the PDA or other wireless communication device such as a mobile phone, a two-way pager, etc., may be loaded with an application program that requests and stores the owner's preferences, such as preferred product names, brands, stores, colors, etc.

The processing steps of the present invention can be implemented by computer programs in conjunction with existing hardware components. Software programming code which embodies the present invention may be stored on any of a variety of known media such as a diskette, hard drive, CD-ROM, or read-only memory, and may be distributed on such media. The techniques and methods for embodying software programming code on physical media and/or distributing software code are known in the art.

Although the present invention has been described with an emphasis of using it in connection with the PDAs carried by individuals to collect the preference information, other wireless communication devices carried by individuals, such as mobile phones, two-way pagers, etc., can be used as long as they store such preference information and are capable of carrying out short-range wireless communications.

In one embodiment, the short-range wireless communication between the PDA (or other wireless communication device) and the communication interface 16 occurs without realization by the individual who carries the PDA as long as the PDA is in a state where communication is enabled. In some embodiments, however, to protect the privacy of individual, the PDA or the like carried by the individual can be configured to communicate with the communication interface 16 selectively, so that information stored in the PDA may not be accessible automatically by the interface 16 even if the PDA is in a state where communication is enabled. This can be accomplished by using security codes or certificates and keys to enable and disable communication between the PDA and the interface 16 according to known techniques.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method for providing personalized customer services to a user using a wireless communication device associated with the user, the method comprising the steps of:
establishing wireless communication with the wireless communication device;
automatically receiving preference information of the user from the wireless communication device through the wireless communication; and
providing, based on the preference information, a personalized customer service in response to a request of a particular customer service from the user.

2. The method of claim 1, wherein the wireless communication device is one of the following: a personal digital assistant (PDA), a mobile phone, or a two-way pager.

3. The method of claim 2, wherein the preference information is prestored in the wireless communication device.

4. The method of claim 1, wherein, in the receiving step, the preference information indicates at least one of the following: products preferred by the user, brands of products preferred by the user, stores preferred by the user, language preferred by the user, and national currency preferred by the user.

5. The method of claim 1, wherein, in the establishing step, the wireless communication is implemented using one of the following: Bluetooth communication techniques, infrared communication techniques, or a combination of Bluetooth communication techniques with LAN (Local Area Network) techniques.

6. The method of claim 1, further comprising:
correlating the preference information with a list of advertisements; and
selecting at least one advertisement from the list of advertisements based on the correlating results according to certain criteria to provide targeted advertising to the user.

7. The method of claim 6, further comprising:
displaying the selected advertisement on a display device of the wireless communication device.

8. The method of claim 1, wherein the wireless communication device is attached to a shopping cart associated with the user.

9. The method of claim 8, further comprising:
reading, by the wireless communication device, the preference information stored in a card carried by the user.

10. The method of claim 9, wherein the card includes one of the following for storing therein the preference information: a RFID tag, a chip, a magnetic strip, or an optical code.

11. The method of claim 9, wherein the providing step includes:
displaying customer service information on a display device of the wireless communication device based on the preference information.

12. The method of claim 1, further comprising:
obtaining, by the wireless communication device, the preference information from a shopping cart attachment device attached to a shopping cart associated with the user.

13. The method of claim 12, further comprising:
obtaining, by the shopping cart attachment device, the preference information by scanning RFID-tagged items placed in the shopping cart wherein the preference information identifies products preferred by the user.

14. The method of claim 13, wherein the wireless communication device is one of the following: a personal digital assistant (PDA), a mobile phone, or a two-way pager.

15. The method of claim 1, wherein, in the providing step, the personalized customer service includes one of the following: providing a particular location or store aisle number at which a product can be found, providing directions to a store, providing a location of a store, providing a language translation of product information, providing a currency conversion, and providing sale and promotional information for a product.

16. A computer program product embodied on computer readable media readable by a computer system, for providing personalized customer services to a user using a wireless communication device associated with the user, the computer program product comprising computer executable instructions for:
establishing wireless communication with the wireless communication device;
automatically receiving preference information of the user from the wireless communication device through the wireless communication; and
providing, based on the preference information, a personalized customer service in response to a request of a particular customer service from the user.

17. The computer program product of claim 16, wherein the preference information is prestored in the wireless communication device, and the wireless communication device is one of the following: a personal digital assistant (PDA), a mobile phone, or a two-way pager.

18. The computer program product of claim 16, wherein the preference information indicates at least one of the following: products preferred by the user, brands of products preferred by the user, stores preferred by the user, language preferred by the user, and national currency preferred by the user.

19. The computer program product of claim 16, wherein the wireless communication is implemented using one of the following: Bluetooth communication techniques, infrared communication techniques, or a combination of Bluetooth communication techniques with LAN (Local Area Network) techniques.

20. The computer program product of claim 16, further comprising computer executable instructions for:
correlating the preference information with a list of advertisements; and
selecting at least one advertisement from the list of advertisements based on the correlating results according to certain criteria to provide targeted advertising to the user.

21. The computer program product of claim 20, further comprising computer executable instructions for:
displaying the selected advertisement on a display device of the wireless communication device.

22. The computer program product of claim 16, wherein the wireless communication device is attached to a shopping cart associated with the user.

23. The computer program product of claim 22, further comprising computer executable instructions for:
reading, by the wireless communication device, the preference information stored in a card carried by the user.

24. The computer program product of claim 23, wherein the card includes one of the following for storing therein the preference information: a RFID tag, a chip, a magnetic strip, or an optical code.

25. The computer program product of claim 23, wherein the computer executable instructions for providing the personalized customer service include computer executable instructions for:
displaying customer service information on a display device of the wireless communication device based on the preference information.

26. The computer program product of claim 16, further comprising computer executable instructions for:
obtaining, by the wireless communication device, the preference information from a shopping cart attachment device attached to a shopping cart associated with the user.

27. The computer program product of claim 26, further comprising computer executable instructions for:
obtaining, by the shopping cart attachment device, the preference information by scanning RFID-tagged items placed in the shopping cart wherein the preference information identifies products preferred by the user.

28. The computer program product of claim 27, wherein the wireless communication device is one of the following: a personal digital assistant (PDA), a mobile phone, or a two-way pager.

29. The computer program product of claim 16, wherein the personalized customer service includes one of the following: providing a particular location or store aisle number at which a product can be found, providing directions to a store, providing a location of a store, providing a language translation of product information, providing a currency conversion, and providing sale and promotional information for a product.

30. A system for providing personalized customer service to a user using a wireless communication device associated with the user, the system comprising:
a communication interface for establishing wireless communication with the wireless communication device and automatically receiving preference information of the user from the wireless communication device through the wireless communication; and
a processor, operatively coupled to the communication interface, for providing, based on the preference information, a personalized customer service in response to a request of a particular customer service from the user.

31. The system of claim 30, wherein the system comprises the wireless communication device being one of the following: a personal digital assistant (PDA), a mobile phone, or a two-way pager, and wherein the preference information is prestored in the wireless communication device.

32. The system of claim 30, wherein the preference information indicates at least one of the following: products preferred by the user, brands of products preferred by the user, stores preferred by the user, language preferred by the user, and national currency preferred by the user.

33. The system of claim 30, wherein the wireless communication is implemented using one of the following: Bluetooth communication techniques, infrared communication techniques, or a combination of Bluetooth communication techniques with LAN (Local Area Network) techniques.

34. The system of claim 30, wherein the processor correlates the preference information with a list of advertisements, and selects at least one advertisement from the list of advertisements based on the correlating results according to certain criteria to provide targeted advertising to the user.

35. The system of claim 34, wherein the wireless communication device includes a display device, and the processor displays the selected advertisement on the display device of the wireless communication device.

36. The system of claim 30, wherein the system comprises the wireless communication device which is attached to a shopping cart associated with the user.

37. The system of claim 36, wherein the wireless communication device includes:
a card reader for reading the preference information stored in a card carried by the user,
a CPU, coupled to the card reader, for receiving the preference information from the card reader, and
an interface, coupled to the CPU, for communicating the preference information to the communication interface.

38. The system of claim 37, wherein the card includes one of the following for storing therein the preference information: a RFID tag, a chip, a magnetic strip, or an optical code.

39. The system of claim 30, wherein the personalized customer service includes one of the following: providing a particular location or store aisle number at which a product can be found, providing directions to a store, providing a location of a store, providing a language translation of product information, and providing a currency conversion, providing sale and promotional information for a product.

40. The system of claim 30, further comprising:
a first storage, accessible by the processor, for storing a plurality of advertisements; and
a second storage, accessible by the processor, for storing information associated with providing the personalized customer service.

41. A method for providing personalized customer services to a user using a wireless communication device associated with the user, the method comprising the steps of:
establishing wireless communication with the wireless communication device;
reading, by the wireless communication device, identification information stored in a card carried by the user;
receiving the identification information from the wireless communication device through the wireless communication;
retrieving preference information of the user based on the identification information; and
providing, based on the preference information, a personalized customer service in response to a request of a particular customer service from the user.

42. The method of claim 41, wherein the identification information identifies a unique customer identification assigned to the user.

43. The method of claim 41, wherein the preference information indicates at least one of the following: products preferred by the user, brands of products preferred by the user, stores preferred by the user, language preferred by the user, and national currency preferred by the user.

44. The method of claim 41, wherein, in the establishing step, the wireless communication is implemented using one of the following: Bluetooth communication techniques, infrared communication techniques, or a combination of Bluetooth communication techniques with LAN (Local Area Network) techniques.

45. The method of claim 41, further comprising:
correlating the preference information with a list of advertisements, and
selecting at least one advertisement from the list of advertisements based on the correlating results according to certain criteria to provide targeted advertising to the user.

46. The method of claim 45, further comprising:
displaying the selected advertisement on a display device of the wireless communication device.

47. The method of claim 41, wherein the wireless communication device is attached to a shopping cart associated with the user.

48. The method of claim 41, wherein the card includes one of the following for storing therein the identification information: a RFID tag, a chip, a magnetic strip, or an optical code.

49. The method of claim 41, wherein the personalized customer service includes one of the following: providing a particular location or store aisle number at which a product can be found, providing directions to a store, providing a location of a store, providing a language translation of product information, providing a currency conversion, and providing sale and promotional information for a product.

50. A computer program product embodied on computer readable media readable by a computer system, for providing personalized customer services to a user using a wireless communication device associated with the user, the computer program product comprising computer executable instructions for:
establishing wireless communication with the wireless communication device;
receiving identification information from the wireless communication device through the wireless communication, the identification information being read by the wireless communication device from a card carried by the user;
retrieving preference information of the user based on the identification information; and
providing, based on the preference information, a personalized customer service in response to a request of a particular customer service from the user.

51. The computer program product of claim 50, wherein the identification information identifies a unique customer identification assigned to the user.

52. The computer program product of claim 50, wherein the preference information indicates at least one of the following: products preferred by the user, brands of products preferred by the user, stores preferred by the user, language preferred by the user, and national currency preferred by the user.

53. The computer program product of claim 50, wherein the wireless communication is implemented using one of the following: Bluetooth communication techniques, infrared communication techniques, or a combination of Bluetooth communication techniques with LAN (Local Area Network) techniques.

54. The computer program product of claim 50, further comprising computer executable instructions for:
correlating the preference information with a list of advertisements, and
selecting at least one advertisement from the list of advertisements based on the correlating results according to certain criteria to provide targeted advertising to the user.

55. The computer program product of claim 54, further comprising computer executable instructions for:
displaying the selected advertisement on a display device of the wireless communication device.

56. The computer program product of claim 50, wherein the wireless communication device is attached to a shopping cart associated with the user.

57. The computer program product of claim 50, wherein the card includes one of the following for storing therein the identification information: a RFID tag, a chip, a magnetic strip, or an optical code.

58. The computer program product of claim 50, wherein the personalized customer service includes one of the following: providing a particular location or store aisle number at which a product can be found, providing directions to a store, providing a location of a store, providing a language translation of product information, providing a currency conversion, and providing sale and promotional information for a product.

59. A system for providing personalized customer services to a user using a wireless communication device associated with the user, the system comprising:
a communication interface for establishing wireless communication with the wireless communication device and receiving, through the wireless communication, identification information from the wireless communication device, the identification information being read by the wireless communication device from a card associated with the user; and
a processor, operatively coupled to the communication interface, for retrieving preference information of the user based on the identification information, and providing, based on the preference information, a personalized customer service in response to a request of a particular customer service from the user.

60. The system of claim 59, wherein the identification information identifies a unique customer identification assigned to the user.

61. The system of claim 59, wherein the preference information indicates at least one of the following: products preferred by the user, brands of products preferred by the user, stores preferred by the user, language preferred by the user, and national currency preferred by the user.

62. The system of claim 59, wherein the wireless communication is implemented using one of the following: Bluetooth communication techniques, infrared communication techniques, or a combination of Bluetooth communication techniques with LAN (Local Area Network) techniques.

63. The system of claim 59, wherein the processor correlates the preference information with a list of advertisements, and selects at least one advertisement from the list of advertisements based on the correlating results according to certain criteria to provide targeted advertising to the user.

64. The system of claim 63, wherein the wireless communication device includes a display device, and the processor displays the selected advertisement on the display device of the wireless communication device.

65. The system of claim 59, wherein the system comprises the wireless communication device which is attached to a shopping cart associated with the user.

66. The system of claim 65, wherein the wireless communication device includes:
a card reader for reading the identification information stored in the card carried by the user,
a CPU, coupled to the card reader, for receiving the identification information from the card reader, and
an interface, coupled to the CPU, for communicating the identification information to the communication interface.

67. The system of claim 66, wherein the card includes one of the following for storing therein the identification information: a RFID tag, a chip, a magnetic strip, or an optical code.

68. The system of claim 59, wherein the personalized customer service includes one of the following: providing a particular location or store aisle number at which a product can be found, providing directions to a store, providing a location of a store, providing a language translation of product information, and providing a currency conversion, providing sale and promotional information for a product.
